(19) United States
(12) Patent Application Publication
(10) Pub. No.: US 2023/0281495 A1
(43) Pub. Date: Sep. 7, 2023

(54) EQUILIBRIUM SOLUTION SEARCH METHOD AND INFORMATION PROCESSING APPARATUS

(71) Applicant: Fujitsu Limited, Kawasaki-shi (JP)

(72) Inventors: Hayato Dan, Yokohama (JP); Natsuki Ishikawa, Yamato (JP); Katsumi Homma, Kawasaki (JP); Masatoshi OGAWA, Zama (JP)

(73) Assignee: Fujitsu Limited, Kawasaki-shi (JP)

(21) Appl. No.: 17/983,855

(22) Filed: Nov. 9, 2022

(30) Foreign Application Priority Data
Mar. 3, 2022 (JP) 2022-032959

(51) Int. Cl. G06N 7/00

(52) U.S. Cl. CPC G06N 7/005

(57) ABSTRACT

An information processing apparatus calculates a plurality of first evaluation values respectively corresponding to a plurality of actions on the basis of probability distribution information indicating the selection probability of each of the plurality of actions. When the plurality of first evaluation values include a negative evaluation value, the information processing apparatus converts the plurality of first evaluation values to a plurality of second evaluation values that are non-negative, using a negative reference value. The information processing apparatus updates the selection probability of each of the plurality of actions on the basis of the plurality of second evaluation values.

### CROSS-REFERENCE TO RELATED APPLICATION

This application is based upon and claims the benefit of priority of the prior Japanese Patent Application No. 2022-032959, filed on Mar. 3, 2022, the entire contents of which are incorporated herein by reference.

### FIELD

The embodiments discussed herein relate to an equilibrium solution search method and an information processing apparatus.

### BACKGROUND

In a situation where a node stochastically selects one action from a plurality of candidate actions, an information processing apparatus may search for an equilibrium solution for a probability distribution of the plurality of actions. The above simulation approach may be called evolutionary game theory. A set of actions with a certain probability distribution may be called a mixed strategy.

For example, replicator dynamics simulates a competition between nodes with probability distributions of a plurality of actions and calculates an evaluation value for each action. With respect to each action, the replicator dynamics then calculates the ratio of its individual evaluation value to an average evaluation value as a coefficient, and multiplies the most recent selection probability by the coefficient to thereby update the selection probability. This results in increasing the selection probabilities of actions with evaluation values greater than the average evaluation value and decreasing the selection probabilities of actions with evaluation values less than the average evaluation value.

There has been proposed an action determination method that enables a plurality of computers connected to a network to individually and autonomously determine, using game theory, whether to execute a task by itself or to request another computer to execute the task. Further, there has been proposed a scheduling method of scheduling jobs using strategy that integrates MiniMax and Nash equilibrium. Still further, there has been proposed a strategy formulation method of collecting data on rival behavior from a network and formulating a co-opetition strategy using Bayesian game theory. Still further, there has been proposed a matching method of finding matches between a plurality of applicants and a plurality of application targets by finding a subgame perfect equilibrium.

See, for example, Japanese Laid-open Patent Publication No. H09-297690, U.S. Patent Application Publication No. 2012/0315966, U.S. Patent Application Publication No. 2017/0169378, and Japanese Laid-open Patent Publication No. 2019-67158.

### SUMMARY

According to one aspect, there is provided a non-transitory computer-readable storage medium storing a program that causes a computer to perform a process including: calculating a plurality of first evaluation values respectively corresponding to a plurality of actions, based on probability distribution information indicating a selection probability of each of the plurality of actions; converting, upon determining that the plurality of first evaluation values include a negative evaluation value, the plurality of first evaluation values to a plurality of second evaluation values that are non-negative, using a negative reference value; and updating the selection probability of each of the plurality of actions, based on the plurality of second evaluation values.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a view for describing an information processing apparatus according to a first embodiment;

FIG. 2 is a block diagram illustrating a hardware example of an information processing apparatus;

FIG. 3 illustrates an example of players in a simulation;

FIG. 4 illustrates an example of a strategy table;

FIG. 5 is a graph representing an example of updating a learning rate;

FIG. 6 includes graphs each representing an example of how a probability distribution changes;

FIG. 7 is a block diagram illustrating a functional example of the information processing apparatus; and

FIG. 8 is a flowchart illustrating an example of a procedure for an equilibrium solution search.

### DESCRIPTION OF EMBODIMENTS

An evaluation function may output negative evaluation values, depending on a simulation target. In this case, there is a possibility of calculating abnormal selection probabilities that do not appropriately reflect the magnitude relationship between the evaluation values of actions. For example, replicator dynamics may calculate a negative selection probability for an action with a negative evaluation value. In addition, if an average evaluation value is negative, the replicator dynamics calculates a selection probability that has a plus or minus sign opposite to that of the evaluation value. This may result in failing to calculate a proper probability distribution as an equilibrium solution.

Hereinafter, some embodiments will be described with reference to the accompanying drawings.

### First Embodiment

A first embodiment will be described.

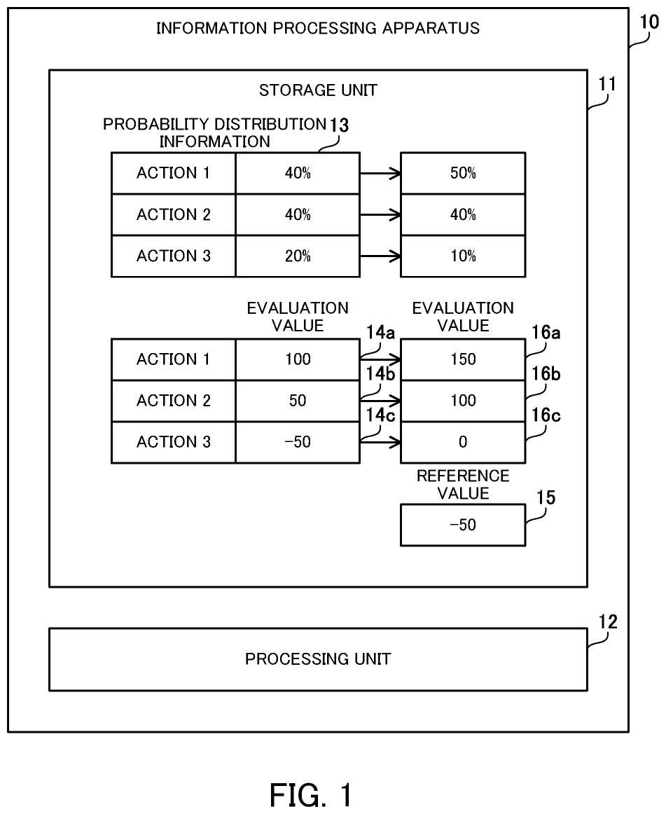

FIG. 1 is a view for describing an information processing apparatus according to the first embodiment.

In a situation where a node stochastically selects one action from a plurality of candidate actions, the information processing apparatus 10 of the first embodiment searches for an equilibrium solution for a probability distribution of the plurality of actions. For example, the information processing apparatus 10 iteratively updates the selection probability of each action using improved discrete replicator dynamics. The information processing apparatus 10 may be a client apparatus or a server apparatus. The information processing apparatus 10 may be called a computer, an equilibrium solution search apparatus, or a simulation apparatus.

The information processing apparatus 10 includes a storage unit 11 and a processing unit 12. The storage unit 11 may be a volatile semiconductor memory such as a random access memory (RAM), or a non-volatile storage device such as a hard disk drive (HDD) or flash memory. The processing unit 12 is a central processing unit (CPU), a graphics processing unit (GPU), a digital signal processor (DSP), or another processor, for example. In this connection, the processing unit 12 may include an electronic circuit such as an application specific integrated circuit (ASIC) or a field programmable gate array (FPGA). For example, the processor executes programs stored in a memory (may be the storage unit 11) such as a RAM. A set of processors may be called a multiprocessor, or simply a “processor.”

The storage unit 11 stores therein probability distribution information 13. The probability distribution information 13 indicates the current selection probabilities respectively for a plurality of actions that are selectable by the node. The node is a decision-making entity that selects an action, and may be called a player. The node may correspond to an apparatus such as a computer. An individual action may be called a strategy or a pure strategy, and a set of actions with a probability distribution may be called a mixed strategy. The node is assumed to randomly select any one action from the probability distribution information 13 with selection probabilities. For example, a first action has a selection probability of 40%, a second action has a selection probability of 40%, and a third action has a selection probability of 20%.

The processing unit 12 calculates a plurality of evaluation values respectively corresponding to the plurality of actions using a predefined evaluation function on the basis of the probability distribution information 13. The evaluation values may be called gains, and the evaluation function may be called a gain function. The evaluation value of an action indicates the advantage of the action in competition between nodes and depends on the competitor's selection of an action. The evaluation value is a numerical value, and a higher numerical value indicates that the action is more advantageous. For example, the processing unit 12 assigns an evaluation target action to one node, assigns an action randomly selected from the probability distribution information 13 to the other node, and calculates an evaluation value for the evaluation target action in the combination of these actions.

For example, the processing unit 12 calculates an evaluation value 14a for the first action, an evaluation value 14b for the second action, and an evaluation value 14c for the third action. Here, the processing unit 12 may obtain a negative numerical value or zero as an evaluation value, depending on the evaluation function used. For example, the evaluation value 14a is calculated to 100, the evaluation value 14b is calculated to 50, and the evaluation value 14c is calculated to −50.

In the case where the plurality of evaluation values calculated by the evaluation function include a negative evaluation value, the processing unit 12 converts the plurality of evaluation values using a reference value 15 that is a negative value so that all the evaluation values become non-negative. For example, the processing unit 12 subtracts the reference value 15 from each of the plurality of evaluation values, in order to convert each evaluation value to a relative evaluation value indicating a difference from the reference value 15. For example, the processing unit 12 converts the evaluation value 14a of the first action to an evaluation value 16a, the evaluation value 14b of the second action to an evaluation value 16b, and the evaluation value 14c of the third action to an evaluation value 16c. For example, the reference value 15 is −50, the evaluation value 16a is 150, the evaluation value 16b is 100, and the evaluation value 16c is 0.

The above reference value 15 may be set to the minimum value of the evaluation values 14a, 14b, and 14c, or may be set to the minimum value of all evaluation values calculated so far. Alternatively, the reference value 15 may be set to a value less than such a minimum value or a predefined lower limit value.

The processing unit 12 updates the selection probability of each of the plurality of actions on the basis of the plurality of converted evaluation values. For example, the processing unit 12 updates the probability distribution information 13 with an update method of replicator dynamics as follows. The processing unit 12 calculates an average evaluation value on the basis of the plurality of converted evaluation values. For example, the average evaluation value is a weighted average evaluation value of the plurality of converted evaluation values weighted by the corresponding current selection probabilities. Then, with respect to each of the plurality of actions, the processing unit 12 calculates the ratio of the converted evaluation value of the action to the average evaluation value as a coefficient, and multiplies the current selection probability by the coefficient to thereby calculate an updated selection probability.

In this connection, the processing unit 12 may update the probability distribution information 13 with an update method of regret minimization dynamics. The regret minimization dynamics takes the difference between the maximum evaluation value of the plurality of actions and the evaluation value of an action as a regret of the action, and decreases the selection probabilities of actions with high regrets.

In addition, as an updated selection probability for an action, the processing unit 12 may calculate a weighted average of the selection probability before update and a new selection probability calculated based on a converted evaluation value, instead of using the new selection probability as it is. A weight for the new selection probability may be called a learning rate. For example, the processing unit 12 calculates 60% from the evaluation value 16a of the first action, and updates its selection probability from 40% to 50%. In addition, the processing unit 12 calculates 40% from the evaluation value 16b of the second action, and keeps its selection probability at 40%. In addition, the processing unit 12 calculates 0% from the evaluation value 16c of the third action, and updates its selection probability from 20% to 10%.

The processing unit 12 may iteratively performs the above processes, i.e., the calculation of evaluation values, the conversion of the evaluation values, and the update of selection probabilities. Then, for example, the processing unit 12 outputs a converged probability distribution as an equilibrium solution. The processing unit 12 may display the updated probability distribution information 13 on a display device, may store it in a non-volatile storage device, or may send it to another information processing apparatus. In addition, while iteratively updating the selection probabilities, the processing unit 12 may change the aforementioned learning rate according to the number of iterations or may decrease the learning rate with an increase in the number of iterations.

As described above, the information processing apparatus 10 of the first embodiment calculates a plurality of evaluation values respectively for a plurality of actions on the basis of the current probability distribution. In the case where the calculated evaluation values include a negative evaluation value, the information processing apparatus 10 converts the evaluation values using the reference value 15 so that all the evaluation values become non-negative. Then, the information processing apparatus 10 updates the selection probability of each of the plurality of actions on the basis of the converted evaluation values. The above approach avoids calculating negative selection probabilities and thus avoids calculating abnormal selection probabilities that do not appropriately reflect the magnitude relationship between the evaluation values of the actions. As a result, even in a simulation using an evaluation function that has a possibility of outputting negative evaluation values, a proper probability distribution is calculated as an equilibrium solution.

In this connection, the use of the minimum value of the calculated evaluation values as the reference value 15 allows the magnitude relationship between the evaluation values of the actions to be appropriately reflected on the selection probabilities. In addition, the use of a weighted average of a new selection probability calculated based on a converted evaluation value and a selection probability before update as an updated selection probability prevents, even if the evaluation value of an action in a certain generation is accidentally calculated to zero, the selection probability of the action from being stuck at zero in the subsequent generations. In addition, the use of such weighted averages prevents rapid changes in the selection probabilities and allows the probability distribution information 13 to converge smoothly. Especially, the use of the leaning rate that is decreased with an increase in the number of iterations allows the probability distribution information 13 to converge smoothly.

### Second Embodiment

A second embodiment will now be described.

In a situation where a plurality of players individually and stochastically select one strategy, aiming to maximize their gains, the mixed strategies of the players may converge to a certain equilibrium solution through competition. An information processing apparatus 100 according to the second embodiment searches for this equilibrium solution through simulations. The equilibrium solution search executed by the information processing apparatus 100 is applicable to analysis and institutional planning for a large-scale social system such as a supply chain.

The information processing apparatus 100 calculates an equilibrium solution in mixed strategies using replicator dynamics. The information processing apparatus 100 may be a client apparatus or a server apparatus. The information processing apparatus 100 may be called a computer, an equilibrium solution search apparatus, or a simulation apparatus. The information processing apparatus 100 corresponds to the information processing apparatus 10 of the first embodiment.

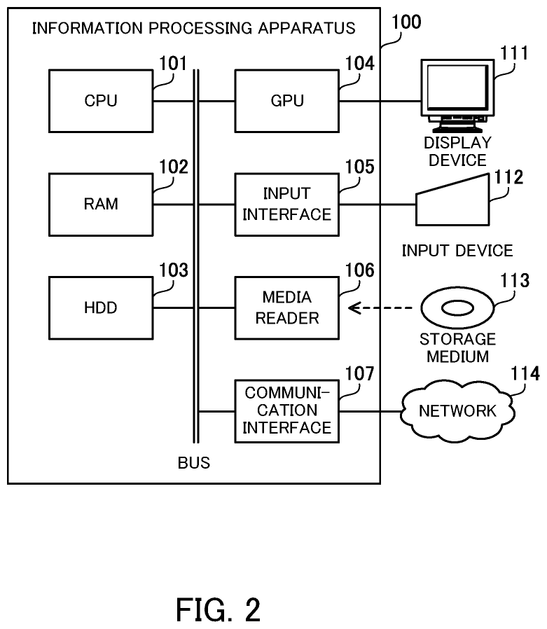

FIG. 2 is a block diagram illustrating a hardware example of an information processing apparatus.

The information processing apparatus 100 includes a CPU 101, a RAM 102, an HDD 103, a GPU 104, an input interface 105, a media reader 106, and a communication interface 107, which are connected to a bus. The CPU 101 corresponds to the processing unit 12 of the first embodiment. The RAM 102 or the HDD 103 corresponds to the storage unit 11 of the first embodiment.

The CPU 101 is a processor that executes program instructions. The CPU 101 loads at least part of a program and data from the HDD 103 to the RAM 102 and executes the program. The information processing apparatus 100 may include a plurality of processors. A set of processors may be called a multiprocessor, or simply a “processor.”

The RAM 102 is a volatile semiconductor memory that temporarily stores therein programs to be executed by the CPU 101 and data to be used by the CPU 101 in processing. The information processing apparatus 100 may include a different type of volatile memory than RAM.

The HDD 103 is a non-volatile storage device that stores therein software programs such as an operating system (OS), middleware, and application software, and data. The information processing apparatus 100 may include other types of non-volatile storage devices such as a flash memory and a solid state drive (SSD).

The GPU 104 performs image processing in conjunction with the CPU 101 and outputs images to a display device 111 connected to the information processing apparatus 100. Examples of the display device 111 include a cathode ray tube (CRT) display, a liquid crystal display (LCD), an organic electro-luminescence (EL) display, and a projector. Other types of output devices such as a printer may be connected to the information processing apparatus 100.

In addition, the GPU 104 may be used as a general-purpose computing on graphics processing unit (GPGPU). The GPU 104 is able to execute programs in accordance with commands from the CPU 101. The information processing apparatus 100 may include a volatile semiconductor memory other than the RAM 102 as a GPU memory that is used by the GPU 104.

The input interface 105 receives input signals from an input device 112 connected to the information processing apparatus 100. Examples of the input device 112 include a mouse, a touch panel, and a keyboard. Plural types of input devices may be connected to the information processing apparatus 100.

The media reader 106 is a reading device that reads programs and data from a storage medium 113. Examples of the storage medium 113 include a magnetic disk, an optical disc, and a semiconductor memory. Magnetic disks include flexible disks (FDs) and HDDs. Optical discs include compact discs (CDs) and digital versatile discs (DVDs). The media reader 106 copies a program or data read from the storage medium 113 into the RAM 102, HDD 103, or another storage medium. The read program may be executed by the CPU 101.

The storage medium 113 may be a portable storage medium and may be used for distribution of programs and data. In addition, the storage medium 113 and HDD 103 may be called computer-readable storage media.

The communication interface 107 communicates with other information processing apparatuses over a network 114. The communication interface 107 may be a wired communication interface that is connected to a switch, a router, or another wired communication device or may be a wireless communication interface that is connected to a base station, an access point, or another wireless communication device.

The following describes replicator dynamics. The information processing apparatus 100 defines a strategy set including a plurality of strategies that are selectable by a player, and initializes a probability distribution of the plurality of strategies. For example, the initial probability distribution is a uniform distribution in which the selection probabilities of all strategies are uniform. The information processing apparatus 100 calculates a gain for each of the plurality of strategies on the basis of a predefined gain function and the tendency of competitor strategy indicated by the current probability distribution. The information processing apparatus 100 updates the selection probability of each of the plurality of strategies on the basis of the calculated gains.

In the case of using pure replicator dynamics, the information processing apparatus 100 updates the selection probability of the i-th strategy with equation (1). In equation (1), xᵢ(k) denotes the selection probability of the i-th strategy in the k-th generation, and xᵢ(k+1) denotes the selection probability of the i-th strategy in the (k+1)-th generation. In addition, pᵢ(k) denotes the gain of the i-th strategy in the k-th generation. x(k) denotes a vector listing the selection probabilities of all strategies in the k-th generation, and p(k) denotes a vector listing the gains of all strategies in the k-th generation.

$${x}_{i} ( k + 1 ) = \frac{{p}_{i} ( k )}{{p ( k )}^{T} x ( k )} {x}_{i} ( k ) \\ where p ( k ) = {\{ {p}_{1} ( k ) , … , {p}_{n} ( k ) \}}^{T} , x ( k ) = {\{ {x}_{1} ( k ) , … , {x}_{n} ( k ) \}}^{T} \qquad ( 1 )$$

Therefore, the information processing apparatus 100 calculates the ratio of the gain of a strategy under consideration to the average gain of all strategies as a coefficient, and multiplies the selection probability in the current generation by the coefficient to calculate the selection probability in the next generation. Here, the average gain is a weighted average gain of the gains of all strategies weighted by the corresponding selection probabilities. By doing so, the selection probability of a strategy with a gain greater than the average gain is increased in proportion to the deviation from the average gain, and the selection probability of a strategy with a gain less than the average gain is decreased in proportion to the deviation from the average gain.

However, in the case of using a gain function that has a possibility of outputting not only positive gains but also gains that are less than or equal to zero, the above-described pure replicator dynamics may fail to correctly calculate a probability distribution. If the gain function outputs a negative gain for a strategy, a negative selection probability may be calculated for the strategy. In addition, in the case where a negative average gain is obtained, selection probabilities each having a plus or minus sign opposite to that of the corresponding gain may be calculated. Furthermore, if the gain function outputs a gain of zero in the k-th generation, the selection probability is calculated to zero in the (k+1)-th generation and is stuck at zero in the subsequent generations, irrespective of the gain.

If a selection probability less than or equal to zero is calculated for at least one strategy, an abnormal probability distribution that does not appropriately reflect the magnitude relationship between the gains of strategies may be calculated. In addition, if a negative selection probability is calculated for at least one strategy, the information processing apparatus 100 may output an error, which means that the equilibrium solution search has failed.

To address this, the information processing apparatus 100 of the second embodiment executes improved replicator dynamics, in place of the above-described pure replicator dynamics. The improved replicator dynamics calculates a selection probability from equation (2) using gains. In equation (2), η(k) denotes a learning rate in the k-th generation. The learning rate is a predefined numerical value that is greater than zero and less than one. The learning rate may be a fixed value or may vary with an increase in the generation number. p(k) denotes the minimum value of the gains from all strategies of all generations. If the gain function outputs a negative gain even once, the minimum gain p(k) is a negative value. I denotes a vector of all ones in all dimensions.

$${x}_{i} ( k + 1 ) = ( 1 - η ( k ) ) {x}_{i} ( k ) + η ( k ) \frac{{p}_{i} ( k ) - \underline{p} ( k )}{{( p ( k ) - \underline{p} ( k ) I )}^{T} x ( k )} {x}_{i} ( k ) \\ where \underline{p} ( k ) = {min}_{j , ℓ} {p}_{j} ( ) \qquad ( 2 )$$

Therefore, the information processing apparatus 100 subtracts the common minimum value from the gain of each strategy to thereby convert the gains of the strategies to relative gains that are greater than or equal to zero. The information processing apparatus 100 calculates the ratio of the relative gain of a strategy under consideration to the average relative gain of all strategies as a coefficient, and multiplies the selection probability in the current generation by the coefficient. By doing so, no negative selection probability is calculated in any generation. In addition, as the selection probability in the next generation, the information processing apparatus 100 uses a weighted average of the selection probability in the current generation and a new selection probability obtained by multiplying the selection probability in the current generation by the coefficient, instead of using the new selection probability as it is. With this, even when the relative gain in a certain generation is accidentally calculated to zero, the selection probability is not calculated to zero in the next generation, and is not stuck at zero in the subsequent generations.

The following describes a supply chain as a simulation example.

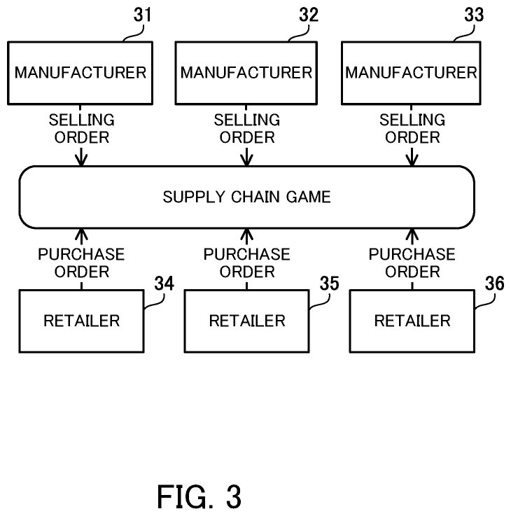

FIG. 3 illustrates an example of players in a simulation.

A supply chain includes manufacturers 31, 32, and 33 and retailers 34, 35, and 36 as players. The manufacturers 31, 32, and 33 purchase raw materials from raw material suppliers, manufacture products, and ship the products to the retailers 34, 35, and 36. The retailers 34, 35, and 36 purchase the products from the manufacturers 31, 32, and 33 and sell them to consumers. The consumer demand quantity randomly varies according to a predefined normal distribution, and corresponds to an external environment that the retailers 34, 35, and 36 are not able to control.

The manufacturers 31, 32, and 33 and retailers 34, 35, and 36 each select one strategy as a stock strategy. The manufacturers 31, 32, and 33 each determine a desired shipment quantity on the basis of the selected strategy, and present a selling order including the desired shipment quantity to the market. The retailers 34, 35, and 36 each determine a desired purchase quantity on the basis of the selected strategy and present a purchase order including the desired purchase quantity to the market. The manufacturers 31, 32, and 33 and retailers 34, 35, and 36 continuously carry out 30 transactions (for example, once daily for 30 days) on the basis of the selected strategies.

For example, the manufacturers 31, 32, and 33 each set a fixed production quantity per day, and present a quantity obtained by adding the current stock quantity and the production quantity as a desired shipment quantity. On the other hand, for example, the retailers 34, 35, and 36 each set a fixed safety stock quantity, and present a quantity obtained by adding an expected consumer demand quantity and the safety stock quantity and subtracting the current stock quantity from the addition result, as a desired purchase quantity.

The information processing apparatus 100 executes a supply chain game on the basis of the selling orders of the manufacturers 31, 32, and 33 and the purchase orders of the retailers 34, 35, and 36. The information processing apparatus 100 determines a shipment quantity for each manufacturer 31, 32, and 33 and a purchase quantity for each retailer 34, 35, and 36 according to the balance between supply and demand.

The manufacturers 31, 32, and 33 may be able to ship only products of quantities that are less than their desired shipment quantities, and the retailers 34, 35, and 36 may be able to purchase only products of quantities that are less than their desired purchase quantities. In addition, the retailers 34, 35, and 36 may be able to sell only products of quantities that are less than their expected consumer demand quantities. Therefore, depending to the selected strategies, the manufacturers 31, 32, and 33 and retailers 34, 35, and 36 have risks of many stocks remaining when the 30 transactions are complete.

The gain of each manufacturer 31, 32, and 33 is gross profit that is calculated by subtracting the cost of raw materials purchased from the raw material suppliers from the sales amount of products sold to the retailers 34, 35, and 36. Because of the stock risk, the gains of the manufacturers 31, 32, and 33 may be positive (surplus), zero, or negative (deficit). On the other hand, the gain of each retailer 34, 35, and 36 is gross profit that is calculated by subtracting the cost of products purchased from the manufacturers 31, 32, and 33 from the sales amount of products to consumers. Because of the stock risk, the gains of the retailers 34, 35, and 36 may be positive, zero, or negative.

The manufacturers 31, 32, and 33 form a player group, and individually and stochastically select one strategy on the basis of the same mixed strategy. On the other hand, the retailers 34, 35, and 36 form a player group, and individually and stochastically select one strategy on the basis of the same mixed strategy. The information processing apparatus 100 optimizes the manufacturers' mixed strategy and the retailers' mixed strategy separately. In this connection, the manufacturers' mixed strategy and the retailers' mixed strategy mutually influence each other. Therefore, when calculating a gain, the information processing apparatus 100 selects a strategy for each of the manufacturers 31, 32, and 33 and retailers 34, 35, and 36 and carries out a simulation.

When calculating the gain of one of the manufacturers' strategies, the information processing apparatus 100 takes the manufacturer 31 as the own player, and takes the other manufacturers 32 and 33 and retailers 34, 35, and 36 as the other players. Then, the information processing apparatus 100 randomly selects a strategy for each of the manufacturers 32 and 33 from the manufacturers' mixed strategy and randomly selects a strategy for each of the retailers 34, 35, and 36 from the retailers' mixed strategy. On the other hand, when calculating the gain of one of the retailers' strategies, the information processing apparatus 100 takes the retailer 34 as the own player, and takes the other manufacturers 31, 32, and 33 and retailers 35 and 36 as the other players. Then, the information processing apparatus 100 randomly selects a strategy for each of the manufacturers 31, 32, and 33 from the manufacturers' mixed strategy and randomly selects a strategy for each of the retailers 35 and 36 from the retailers' mixed strategy.

Since a single gain calculation is affected by the contingency of competitors' selection of strategies, the information processing apparatus 100 iteratively calculates a gain for each strategy multiple times, and then calculates the average of the gains obtained in the iterative calculations as an expected gain. When having calculated an expected gain for each strategy, the information processing apparatus 100 updates the selection probability of each of the manufacturers' strategies, and independently of the manufacturers' strategies, updates the selection probability of each of the retailers' strategies.

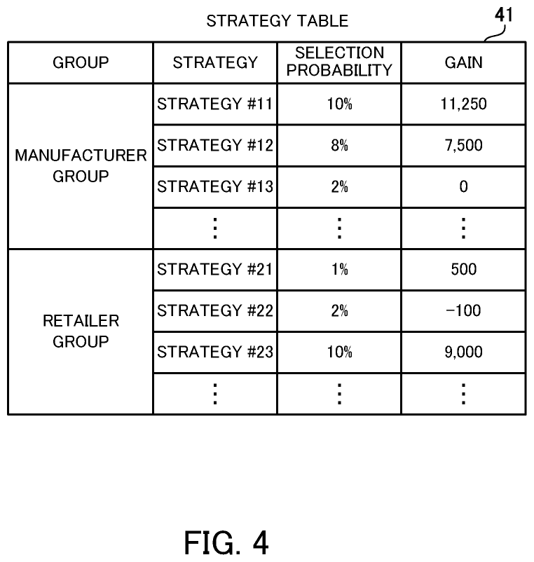

FIG. 4 illustrates an example of a strategy table.

The strategy table 41 is stored in the information processing apparatus 100 during an equilibrium solution search of mixed strategies. The strategy table 41 lists strategies for the manufacturer group of the manufacturers 31, 32, and 33 and strategies for the retailer group of the retailers 34, 35, and 36.

In addition, the strategy table 41 contains the selection probability of each of the plurality of strategies in the current generation. The total selection probability of the strategies for the manufacturer group is one, and the total selection probability of the strategies for the retailer group is one. A column of the selection probabilities for the manufacturer group forms one probability distribution and corresponds to a mixed strategy of the manufacturer group. Likewise, a column of the selection probabilities for the retailer group forms one probability distribution and corresponds to a mixed strategy of the retailer group. In addition, the strategy table 41 contains the gain of each of the plurality of strategies in the current generation. The gains are used for updating the selection probabilities. In this connection, the information processing apparatus 100 further stores the above-described minimum gain p.

The following describes the above-described learning rate η.

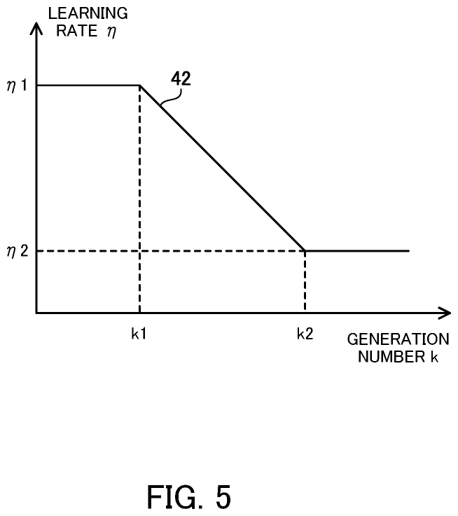

FIG. 5 is a graph representing an example of updating the learning rate.

The learning rate η preferably decreases with an increase in the generation number k. That is, as the generation number k increases, a weight for selection probabilities before update preferably increases, and a weight for new selection probabilities calculated based on gains preferably decreases. For example, the information processing apparatus 100 determines the learning rate η according to a curve 42. The curve 42 defines the following: the learning rate η is η1 until the generation number k reaches k1, and after the generation number k exceeds k1, the learning rate η linearly decreases until the generation number k reaches k2. After the generation number k exceeds k2, the learning rate η is fixed to η2.

In this connection, the information processing apparatus 100 does not fix the relationship between the generation number k and the learning rate η, but may change the learning rate η while monitoring the convergence state of a probability distribution. The learning rate η preferably decreases when the probability distribution is sufficiently converged. For example, the information processing apparatus 100 extracts some strategies in descending order of selection probability from a mixed strategy in the current generation, and extracts some strategies in descending order of selection probability from the mixed strategy in one past generation Or some past generations. The information processing apparatus 100 then determines that the probability distribution is converged when the order of higher-ranked strategies does not change.

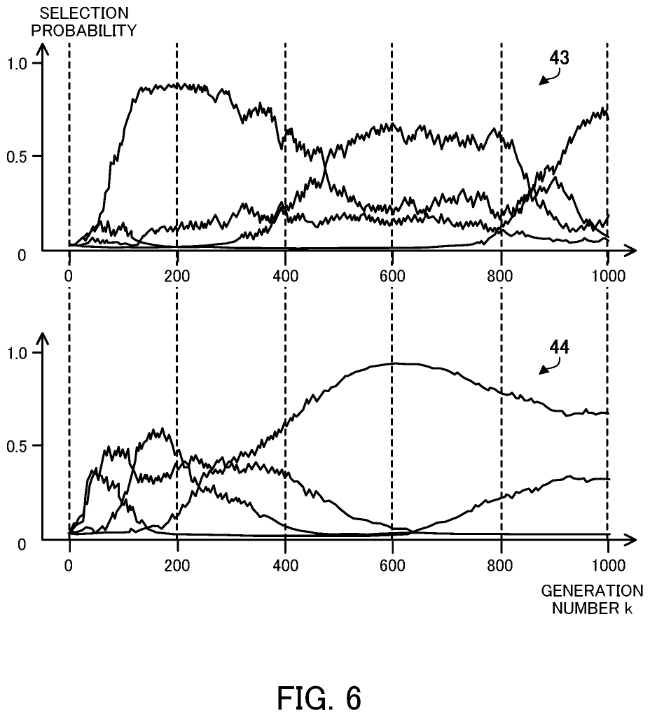

FIG. 6 includes graphs each representing an example of how a probability distribution changes.

A graph 43 represents the relationships between the generation number k and the selection probabilities of four strategies in the case where the learning rate η is fixed to a certain value. A graph 44 represents the relationships between the generation number k and the selection probabilities of four strategies in the case where the learning rate η is dynamically updated. As seen in the graphs 43 and 44, the dynamic update of the learning rate η prevents the selection probabilities from rapidly changing with an increase in the generation number k and allows the selection probabilities to converge smoothly and stably.

The following describes the functions and processing procedure of the information processing apparatus 100.

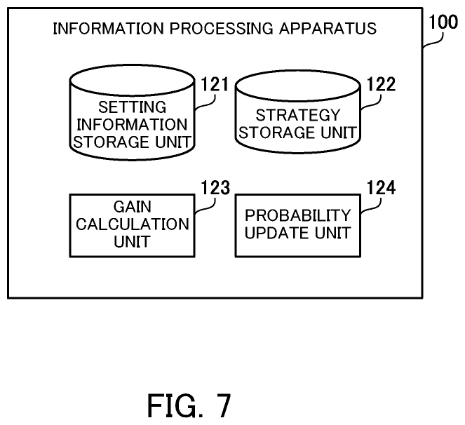

FIG. 7 is a block diagram illustrating a functional example of the information processing apparatus.

The information processing apparatus 100 includes a setting information storage unit 121, a strategy storage unit 122, a gain calculation unit 123, and a probability update unit 124. The setting information storage unit 121 and strategy storage unit 122 are implemented by using the RAM 102 or HDD 103, for example. The gain calculation unit 123 and probability update unit 124 are implemented by using the CPU 101 and programs, for example.

The setting information storage unit 121 stores therein setting information. The setting information includes a strategy set of strategies that are selectable by players and a gain function of calculating gains. In addition, the setting information includes parameters such as an upper limit for the number of iterations of strategy sampling and an upper limit for the generation of a mixed strategy.

The strategy storage unit 122 stores therein a selection probability and gain calculated for each strategy. For example, the strategy table 41 is stored in the strategy storage unit 122. In addition, the strategy storage unit 122 stores therein the minimum gain p determined from all strategies of all generations. In this connection, the minimum gain p may be determined for each individual group or may be determined in common for a plurality of groups.

The gain calculation unit 123 calculates gains respectively for all strategies in each generation. When calculating a gain for one strategy, the gain calculation unit 123 assigns the one strategy to one player, and assigns strategies sampled from mixed strategies with the selection probabilities to the other players. The gain calculation unit 123 calculates the gain of the one player with the gain function. At this time, a random number indicating an external environment may be used. The gain calculation unit 123 iterates the sampling to calculate an expected gain value for the one strategy.

The probability update unit 124 updates the mixed strategy of each group using the gains calculated by the gain calculation unit 123 with the improved replicator dynamics in each generation. At this time, in the case where the gains in the current generation include a gain less than the minimum gain p(k−1) in the previous generation, the probability update unit 124 updates the minimum gain p(k) in the current generation from p(k−1). In addition, the probability update unit 124 determines a learning rate η(k) corresponding to the current generation number k.

The probability update unit 124 converts the gain of each strategy to a relative gain that is greater than or equal to zero, using the minimum gain p(k). Then, with respect to each strategy, the probability update unit 124 multiplies the selection probability xᵢ(k) in the current generation by the ratio of its individual relative gain to the average relative gain to thereby calculate a new selection probability. The probability update unit 124 then weights the selection probability xᵢ(k) and the new selection probability with the leaning rate η(k), and calculates their weighted average as the selection probability xᵢ(k+1) in the next generation.

When the mixed strategies of all groups are converged or the generation number k reaches the upper limit generation number, the probability update unit 124 terminates the iterations and outputs the mixed strategies in the last generation as an equilibrium solution. The probability update unit 124 may display the equilibrium solution on the display device 111, store it in a non-volatile storage device, or send it to another information processing apparatus.

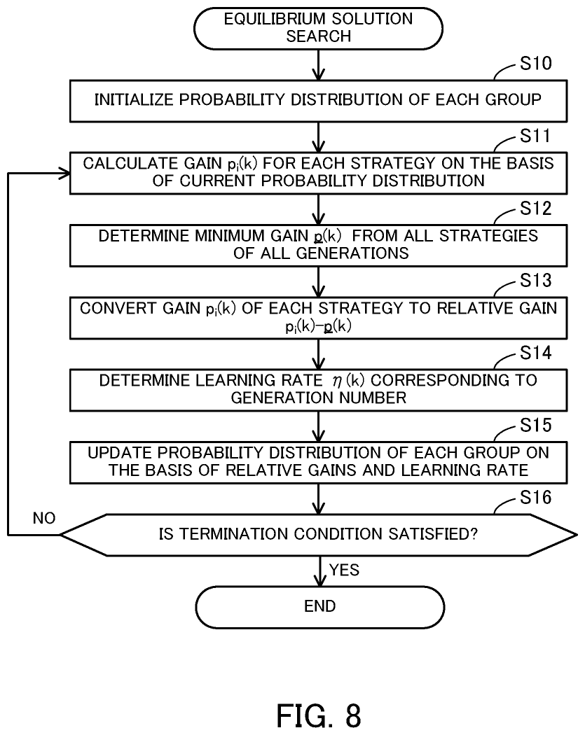

FIG. 8 is a flowchart illustrating an example of a procedure for an equilibrium solution search.

(S10) The probability update unit 124 initializes the probability distribution of each group. For example, the probability update unit 124 sets a uniform probability distribution in which the selection probabilities of a plurality of strategies are uniform.

(S11) The gain calculation unit 123 calculates a gain pᵢ(k) for each strategy on the basis of the current probability distribution. More specifically, the gain calculation unit 123 assigns a target strategy for which a gain is to be calculated to the own player, and assigns strategies randomly selected from mixed strategies to the other players, and calculates the gain of the own player in the combination of the strategies.

The gain calculation unit 123 iteratively samples strategies multiple times to calculate an expected gain value for the target strategy. In this connection, the gain calculation unit 123 iterates the strategy sampling until the number of iterations reaches an upper limit or the expected gain is converged. The gain calculation unit 123 determines that the expected gain is converged when the difference between the current expected gain and the previous expected gain is less than a threshold.

(S12) The probability update unit 124 determines the minimum gain p(k) from all strategies of all generations. For example, the probability update unit 124 extracts the minimum value from the gains calculated at step S11, and compares the minimum value with the saved minimum gain p(k−1). When the minimum value extracted this time is less than the saved minimum gain p(k−1), the probability update unit 124 takes the minimum value extracted this time as p(k). Otherwise, the probability update unit 124 sets p(k) to p(k)=p(k−1).

(S13) The probability update unit 124 converts the gain pᵢ(k) of each strategy calculated at step S11 to a relative gain pᵢ(k)−p(k).

(S14) The probability update unit 124 determines a learning rate η(k) corresponding to the generation number k. For example, the learning rate η(k) decreases with an increase in the generation number k.

(S15) The probability update unit 124 updates the probability distribution of each group on the basis of the relative gains calculated at step S13 and the learning rate η(k) determined at step S14. At this time, with respect to each group, the probability update unit 124 calculates the average relative gain, and for each strategy, calculates the ratio of the relative gain to the average relative gain as a coefficient and multiplies the selection probability by the coefficient to thereby calculate a new selection probability. The probability update unit 124 then weights the selection probability before update and the new selection probability with the learning rate η(k), and calculates their weighted average as an updated selection probability.

(S16) The probability update unit 124 determines whether a termination condition is satisfied. The termination condition is that the generation number k reaches an upper limit generation number or the mixed strategies of all groups are converged. For example, with respect to a mixed strategy, the probability update unit 124 calculates the distance between a vector listing the selection probabilities in the current generation and a vector listing the selection probabilities in the previous generation, and when the distance is less than a threshold, determines that the mixed strategy is converged. If the termination condition is not satisfied, the process goes back to step S11. If the termination condition is satisfied, the probability update unit 124 outputs the mixed strategies of the groups in the last generation as an equilibrium solution.

As described above, the information processing apparatus 100 of the second embodiment calculates gains respectively for a plurality of strategies, and increases the selection probabilities of strategies with high gains and decreases the selection probabilities of strategies with small gains. By doing so, an equilibrium solution of strategies for player groups is found to generate information that is useful for analysis and institutional planning for a large-scale social system such as a supply chain.

In addition, the information processing apparatus 100 converts gains output from the gain function to relative gains using the minimum gain determined from all strategies of all generations, and updates selection probabilities using the relative gains. With this, even when the gain function has a possibility of outputting negative gains, negative selection probabilities are not calculated, which leads to calculating a proper probability distribution that appropriately reflects the magnitude relationship between the gains of strategies.

In addition, the information processing apparatus 100 weights a selection probability before update and a new selection probability calculated based on a gain with a learning rate determined according to a generation number, and calculates their weighted average as an updated selection probability. Even when a relative gain is accidentally calculated to zero in a certain generation, the selection probability is prevented from being stuck at zero in the subsequent generations, which leads to calculating a proper probability distribution. In addition, rapid changes in selection probabilities are prevented. Besides, the information processing apparatus 100 decreases the learning rate with an increase in the generation number, which allows the probability distribution to converge smoothly.

According to one aspect, it is possible to avoid calculating abnormal selection probabilities in updating a probability distribution of actions.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A non-transitory computer-readable storage medium storing a program that causes a computer to perform a process comprising:
calculating a plurality of first evaluation values respectively corresponding to a plurality of actions, based on probability distribution information indicating a selection probability of each of the plurality of actions;
converting, upon determining that the plurality of first evaluation values include a negative evaluation value, the plurality of first evaluation values to a plurality of second evaluation values that are non-negative, using a negative reference value; and
updating the selection probability of each of the plurality of actions, based on the plurality of second evaluation values.

2. The non-transitory computer-readable storage medium according to claim 1, wherein
the negative reference value is less than or equal to a minimum value of the plurality of first evaluation values, and
the converting includes calculating differences between each of the plurality of first evaluation values and the negative reference value.

3. The non-transitory computer-readable storage medium according to claim 1, wherein the updating includes calculating a new selection probability for each of the plurality of actions, based on the plurality of second evaluation values, and calculating, for each of the plurality of actions, a weighted average of the selection probability before the updating and the new selection probability.

4. The non-transitory computer-readable storage medium according to claim 3, wherein
the calculating of the plurality of first evaluation values, the converting, and the updating are iteratively performed, and
the updating includes changing a weight for the new selection probability with an increase in a number of iterations.

5. An equilibrium solution search method comprising:
calculating, by a processor, a plurality of first evaluation values respectively corresponding to a plurality of actions, based on probability distribution information indicating a selection probability of each of the plurality of actions;
converting, by the processor, upon determining that the plurality of first evaluation values include a negative evaluation value, the plurality of first evaluation values to a plurality of second evaluation values that are non-negative, using a negative reference value; and
updating, by the processor, the selection probability of each of the plurality of actions, based on the plurality of second evaluation values.

6. An information processing apparatus comprising:
a memory that stores therein probability distribution information indicating a selection probability of each of a plurality of actions; and
a processor that performs a process including
calculating a plurality of first evaluation values respectively corresponding to the plurality of actions, based on the probability distribution information,
converting, upon determining that the plurality of first evaluation values include a negative evaluation value, the plurality of first evaluation values to a plurality of second evaluation values that are non-negative, using a negative reference value, and
updating the selection probability of each of the plurality of actions, based on the plurality of second evaluation values.
